(19) United States
(12) Patent Application Publication
(10) Pub. No.: US 2015/0029318 A1
(43) Pub. Date: Jan. 29, 2015

(54) CONTENTS-RESPONSIVE KIOSK AND METHOD FOR DRIVING THE SAME

(71) Applicant: Globepoint Inc., Goyang-si (KR)

(72) Inventor: Sang Yong CHO, Gyeonggi-do (KR)

(73) Assignee: Globepoint Inc., Goyang-si (KR)

(21) Appl. No.: 14/141,769

(22) Filed: Dec. 27, 2013

(30) Foreign Application Priority Data
Jul. 24, 2013 (KR) 10-2013-0087181

(51) Int. Cl. H04N 5/655

(52) U.S. Cl. CPC H04N 5/655
USPC 348/77; 348/839

(57) ABSTRACT

Disclosed are a contents-responsive kiosk and a method for driving the same. A support; a screen module attached to an upper end of the support; a contents reception module for receiving contents; a contents determination module for analyzing a tag added to the received contents, and determining whether the contents are horizontal-type contents or vertical-type contents; a screen driving control module for rotating and maintaining the screen module at a horizontal state when the contents are horizontal-type contents as a result of the determination, and for rotating and maintaining the screen module at a vertical state when the contents are vertical-type contents; and a contents reproduction module for reproducing the received contents on the screen module are included.

### FIELD OF THE INVENTION

The present invention relates to a kiosk and a method for driving the same, and more particularly, to a contents-responsive kiosk and a method for driving the same.

### BACKGROUND OF THE INVENTION

The conventional kiosks are used in various places, such as lecture rooms, vehicle selling agencies, roadsides, and the like.

The kiosks are connected to a network so as to be provided with various contents, and are used in various fields, including education and product sale.

For example, a kiosk is configured to reproduce contents for education in a classroom, and a kiosk is configured to display various vehicle galleries in a vehicle agency because all the colors and types of vehicles are not displayed in one vehicle agency.

As described above, the kiosk's function as an information providing apparatus for providing various pieces of information to users. Such kiosks provide various contents for education, for product sale, for information guide, or the like, according to corresponding objects, and each kiosk is used for a specific object.

Each kiosk is required to be optimized for corresponding contents because having an object thereof, such as provision of contents for education, provision of a vehicle gallery, or the like.

Most of kiosks are produced with a screen fixed in a vertical form, but there are many cases that a horizontal-type screen is more suitable than a vertical-type screen according to types of contents.

For example, when a character runs along a path, it is suitable that the image of the path is displayed in a vertical form. Also, it may be more suitable that contents related to a landing simulation on a runway for airplanes are shown in a vertical display.

In contrast, since a vehicle has a horizontally long shape, it is suitable that a vehicle gallery is displayed on a horizontal-type screen.

As described above, when the screen of a kiosk is manufactured in a horizontal form or a vertical form depending on whether contents are horizontal-type contents or vertical-type contents, the user can more conveniently view and feel the contents.

However, the conventional kiosks have a limitation in that only vertical-type screens are mainly manufactured as hardware, regardless of types of contents.

Meanwhile, users have various constitutions and heights depending on adults, children, tall persons, short persons, and the like. However, since the conventional kiosks are manufactured in a fixed shape, the direction of a screen cannot be arranged to suitable for each user. That is to say, children cannot appropriately view a screen of a kiosk when the screen is fixed at a high position. A too tall person also must bend his/her knee or back to view a front screen or to touch the screen.

For these reasons, it is necessary to adaptively control and operate the screen of a kiosk according to the height or direction of a user.

### SUMMARY OF THE INVENTION

In view of the above, the present invention provides a contents-responsive kiosk.

Further, the present invention provides a method for driving a contents-responsive kiosk.

In accordance with a first aspect of the present invention, there is provided a contents-responsive kiosk including: a support; a screen module attached to an upper end of the support; a contents reception module for receiving contents from a cloud server; a contents determination module for analyzing a tag added to the received contents, and determining whether the contents are horizontal-type contents or vertical-type contents; a screen driving control module for rotating and maintaining the screen module at a horizontal state when the contents are horizontal-type contents as a result of the determination, and for rotating and maintaining the screen module at a vertical state when the contents are vertical-type contents; and a contents reproduction module for reproducing the received contents on the screen module.

In this case, the contents determination module may be configured to analyze a tag added according to each frame in the contents during the reproduction of the contents, and to determine whether the corresponding frame is a horizontal-type frame or a vertical-type frame; and the screen driving control module may be configured to rotate and maintain the screen module at a horizontal state when the corresponding frame is a horizontal-type frame as a result of the determination, and to rotate and maintain the screen module at a vertical state when the corresponding frame is a vertical-type frame.

In addition, the contents-responsive kiosk may be configured to further include a camera module which is attached to a predetermined border of the screen module and configured to recognize a user.

In addition, the screen driving control module may be configured to perform a tilt-driving in an up and down direction such that the screen module faces the user recognized by the camera module.

In addition, the kiosk may be configured to further include a motion sensor for recognizing a motion of the user.

In addition, the screen driving control module may be configured to perform a left and right driving such that the screen module faces along a movement direction of the user when a motion of the user recognized by the motion sensor accords with a preset motion.

In accordance with a second aspect of the present invention, there is provided a driving method of a contents-responsive kiosk including: allowing a contents reception module to receive contents from a cloud server; allowing a contents determination module to analyze a tag added to the received contents and to determine whether the contents are horizontal-type contents or vertical-type contents; allowing a screen driving control module to rotate and maintain a screen module, which has been attached to an upper end of a support, at a horizontal state when the contents are horizontal-type contents as a result of the determination, and to rotate and maintain the screen module at a vertical state when the contents are vertical-type contents; allowing a camera module to recognize a user; allowing the screen driving control module to perform a tilt-driving in an up or down direction so as to face the user recognized by the camera module; and allowing a contents reproduction module to reproduce the received contents on the screen module.

In addition, the method may be configured to further include: allowing the contents determination module to analyze a tag added according to each frame in the contents during the reproduction of the contents, and to determine whether the corresponding frame is a horizontal-type frame or a vertical-type frame; and allowing the screen driving control module to rotate and maintain the screen module at a horizontal state when the corresponding frame is a horizontal-type frame as a result of the determination, and to rotate and maintain the screen module at a vertical state when the corresponding frame is a vertical-type frame.

In addition, the method may be configured to further include: allowing a motion sensor to recognize a motion of the user.

In addition, the method may be configured to further include: allowing the screen driving control module to perform a left and right driving such that the screen module faces along a movement direction of the user when a motion of the user recognized by the motion sensor accords with a preset motion.

### BRIEF DESCRIPTION OF THE DRAWINGS

The objects and features of the present invention will become apparent from the following description of embodiments given in conjunction with the accompanying drawings, in which:

FIG. 1 is a block diagram illustrating the configuration of a contents-responsive kiosk according to an exemplary embodiment of the present invention;

FIG. 2 is an exemplary view illustrating the vertical-type driving of the contents-responsive kiosk according to an exemplary embodiment of the present invention;

FIG. 3 is an exemplary view illustrating the horizontal-type driving of the contents-responsive kiosk according to an exemplary embodiment of the present invention;

FIG. 4 is a side view of the contents-responsive kiosk according to an exemplary embodiment of the present invention;

FIG. 5 is a top view of the contents-responsive kiosk according to an exemplary embodiment of the present invention; and

FIG. 6 is a flowchart illustrating a method for driving the contents-responsive kiosk according to an exemplary embodiment of the present invention.

### DETAILED DESCRIPTION OF THE EMBODIMENTS

As the present invention may make various changes and have various forms, it is intended to illustrate specific embodiments in the drawings and describe them in detail. However, it should be understood that this is intended not to limit the present invention to specific disclosed forms but to include all changes, equivalents and replacements that fall within the spirit and technical scope of the present invention. Like reference signs are used for like components in describing each drawing.

Although the terms like a first, a second, A, and B are used to describe various components, the components should not be limited by the terms. The terms may be used for the purpose of distinguishing one component from another. For example, a first component may be named a second component and similarly, a second component may be named a first component without departing from the scope of right of the present invention. The term and/or includes a combination of a plurality of related described items or any of the plurality of related described items.

When being mentioned that a certain component is “connected” or “coupled” to another component, the former may directly be connected or coupled to the latter but the third component may exist between them. On the other hand, when being mentioned that a certain component is “directly connected” or “directly coupled” to another component, it should be understood that the third component does not exist between them.

The terms used herein are just for describing specific embodiments and are not intended to limit the present invention. The terms of a singular form may include plural forms unless clearly otherwise referred to in context. In this application, it should be understood that the term “include,” “comprise,” “have”, “including”, “comprising”, or “having” is intended to specify that there are features, figures, steps, operations, components, parts or their combinations represented in the specification and not to exclude that there may be one or more other features, figures, steps, operations, components, parts, or their combinations or that they may be added.

Unless being otherwise defined, all terms used herein that include technical or scientific terms have the same meaning as those generally understood by those skilled in the art. The terms, such as those defined in dictionaries generally used should be construed to have meaning matching that having in context of the related art and are not construed as ideal or excessively perfunctory meaning unless being clearly defined in this application.

Hereinafter, embodiments of the present invention will be described in detail with reference to the accompanying drawings which form a part hereof.

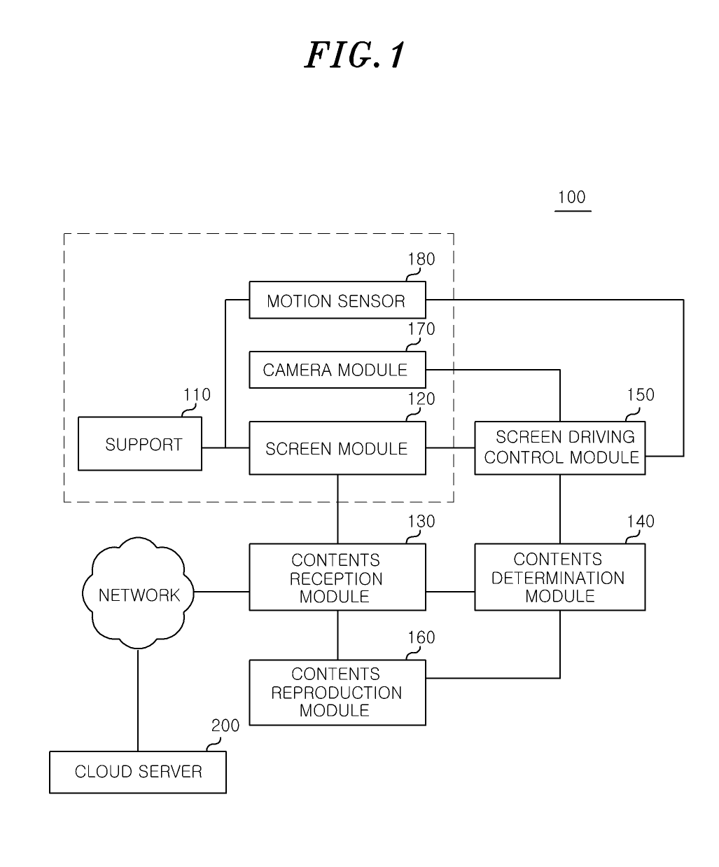

FIG. 1 is a block diagram illustrating the configuration of a contents-responsive kiosk according to an exemplary embodiment of the present invention.

Referring to FIG. 1, a contents-responsive kiosk 100 according to an exemplary embodiment of the present invention may be configured to include a support 110, a screen module 120, a contents reception module 130, a contents determination module 140, a screen driving control module 150, a contents reproduction module 160, a camera module 170, and a motion sensor 180.

The contents-responsive kiosk 100 is configured to determine whether contents are horizontal-type contents or vertical-type contents and to rotate the screen module 120 to a horizontal form or a vertical form.

In addition, the contents-responsive kiosk 100 is configured to recognize a user using the camera module 170 and to tilt-drive the screen module 120 in the up or down direction toward the use so that a tall or short user can easily see a screen.

In addition, the contents-responsive kiosk 100 is configured to sense a motion of the user by means of the motion sensor 180, and is configured to drive the screen module 120 in the left or right direction according to the user when the user moves while performing a preset motion. For example, when the user raises and waves his/her one hand, the contents-responsive kiosk 100 recognizes the motion and moves the screen module 120 in a direction according to the user.

Hereinafter, a detailed construction will be described.

The support 110 is configured such that the lower end thereof is supported on a flat surface and the upper end thereof is provided with the screen module 120 attached to the support 110.

The screen module 120 may be configured to be attached to the support 110, and configured with a touch screen.

The contents reception module 130 may be configured to receive contents from a cloud server 200.

The contents determination module 140 may be configured to analyze a tag added to contents which are received by the contents reception module 130, and may be configured to determine whether the contents are horizontal-type contents or vertical-type contents through the analyzed tag. The tag may be configured to indicate that contents are horizontal-type contents when the contents are horizontal-type contents, and to indicate contents are vertical-type contents when the contents are vertical-type contents. In addition, the tag may be configured to indicate that contents are horizontal-type/vertical-type mixed contents when the contents are horizontal-type/vertical-type mixed contents.

In addition, when contents are horizontal-type/vertical-type mixed contents, the contents determination module 140 may be configured to analyze a tag added according to each frame in contents and to determine whether the frame is a horizontal-type frame or a vertical-type frame during reproduction of the contents.

The screen driving control module 150 may be configured to, according to a result of the determination of the contents determination module 140, rotate the screen module 120 to a horizontal form and to maintain the screen module 120 at the horizontal form when contents are determined to be horizontal-type contents, and to rotate the screen module 120 to a vertical form and to maintain the screen module 120 at the vertical form when contents are determined to be vertical-type contents.

In addition, when contents are horizontal-type/vertical-type mixed contents, the screen driving control module 150 may be configured to, according to a result of determination of each frame, rotate the screen module 120 to a horizontal form and to maintain the screen module 120 at the horizontal form when the frame is determined to be a horizontal-type frame, and to rotate the screen module 120 to a vertical form and to maintain the screen module 120 at the vertical form when the frame is determined to be a vertical-type frame.

The contents reproduction module 160 may be configured to reproduce contents, which are received by the contents reception module 130, on the screen module 120.

The camera module 170 may be configured to be attached on a predetermined border of the screen module 120 and to recognize a user. Preferably, the camera module 170 may be configured to identify the facial contour of a person, the position of his/her eyes and the like in the shape thereof. Accordingly, it is possible to identify the height of the user's eyes are at.

In this case, the screen driving control module 150 may be configured to perform a tilt-driving in an up or down direction so that the screen module 120 can face the user recognized by the camera module 170.

The motion sensor 180 may be configured to recognize a motion of a user. An MS kinetic sensor may be used as the motion sensor 180.

In this case, the screen driving control module 150 may be configured to left or light drive the screen module 120 so that the screen module 120 can face along the movement direction of a user when a motion of the user recognized by the motion sensor 180 accords with a preset motion. For example, the screen module 120 may be configured to move left or right according to a movement direction of a user when the user either raises his/her one arm, or raises and moves his/her one arm in the left or right direction.

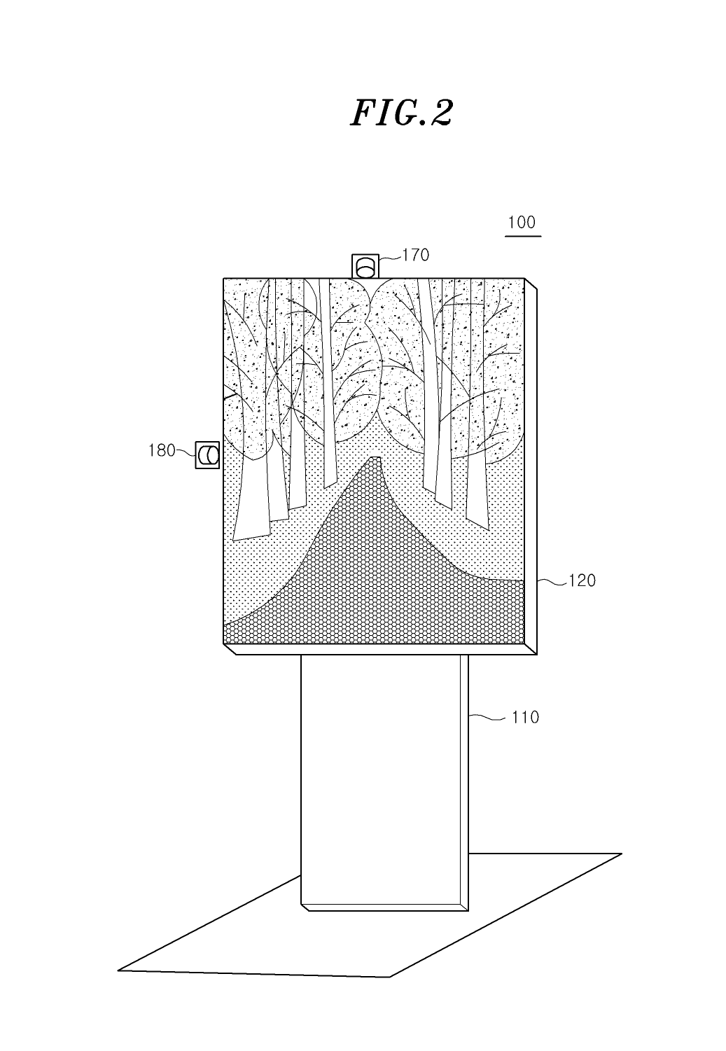

FIG. 2 is an exemplary view illustrating the vertical-type driving of the contents-responsive kiosk according to an exemplary embodiment of the present invention.

Referring to FIG. 2, it can be understood that a path image, which is a vertical-type image, has been displayed on the screen module 120. To this end, the screen module 120 is rotated to a vertical-type form and is maintained at the rotated state.

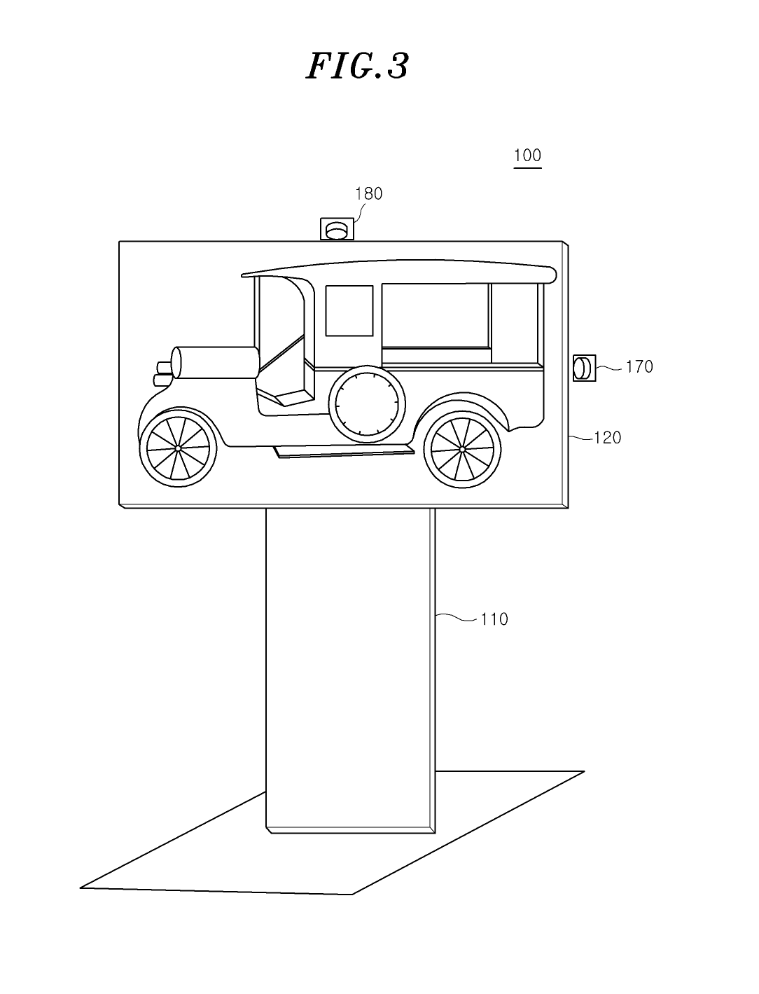

FIG. 3 is an exemplary view illustrating the horizontal-type driving of the contents-responsive kiosk according to an exemplary embodiment of the present invention.

Referring to FIG. 3, it can be understood that a vehicle image, which is a horizontal-type image, has been displayed on the screen module 120. To this end, it can be understood that the screen module 120 is rotated to a horizontal-type form and is maintained at the rotated state.

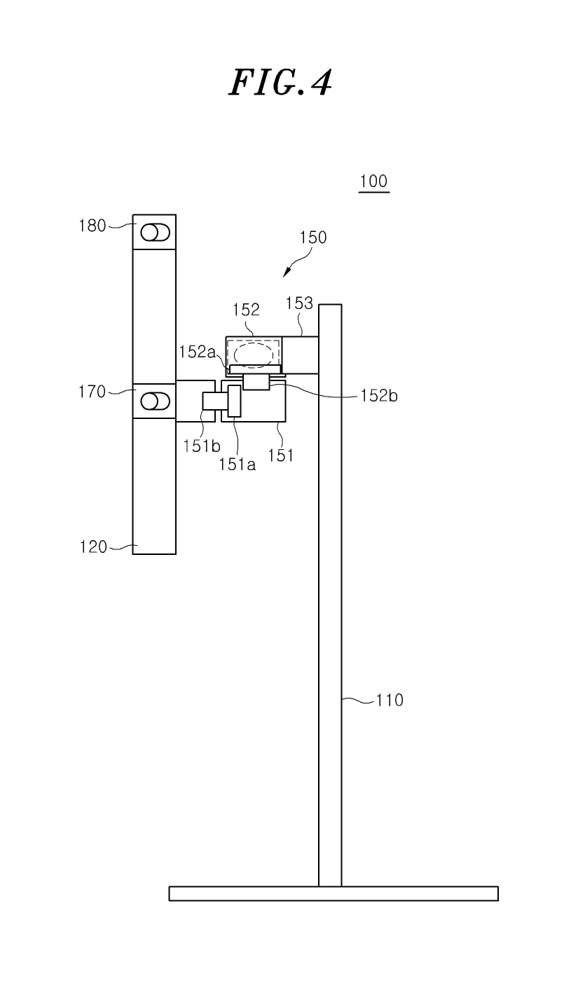

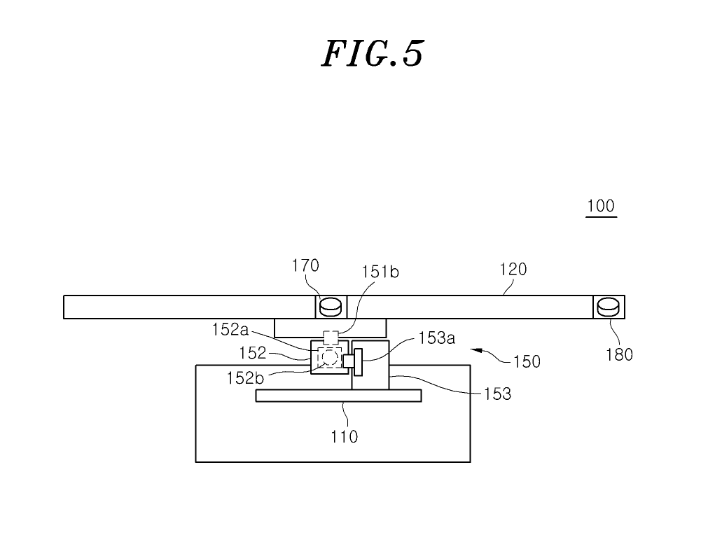

FIG. 4 is a side view of the contents-responsive kiosk according to an exemplary embodiment of the present invention, and FIG. 5 is a top view thereof.

Referring to FIG. 4, the screen driving control module 150 of the contents-responsive kiosk 100 may be configured to include a first rotation base 151, a second rotation base 152, and a third rotation base 153.

Here, the first rotation base 151 may be configured to include a first rotation motor 151a and a first rotation shaft 151b, the second rotation base 152 may be configured to include a second rotation motor 152a and a second rotation shaft 152b, and the third rotation base 153 may be configured to include a third rotation motor 153a and a third rotation shaft 153b.

The first rotation base 151 is used to rotate the screen module 120 to a horizontal form or a vertical form and to maintain the screen module 120 at the rotated state by driving the first rotation motor 151a to rotate the first rotation shaft 151b.

The second rotation base 152 is used to tilt-drive the screen module 120 in up and down directions by driving the second rotation motor 152a to rotate the second rotation shaft 152b.

The third rotation base 153 is used to drive the screen module 120 in left and right directions by driving the third rotation motor 153a to rotate the third rotation shaft 153b.

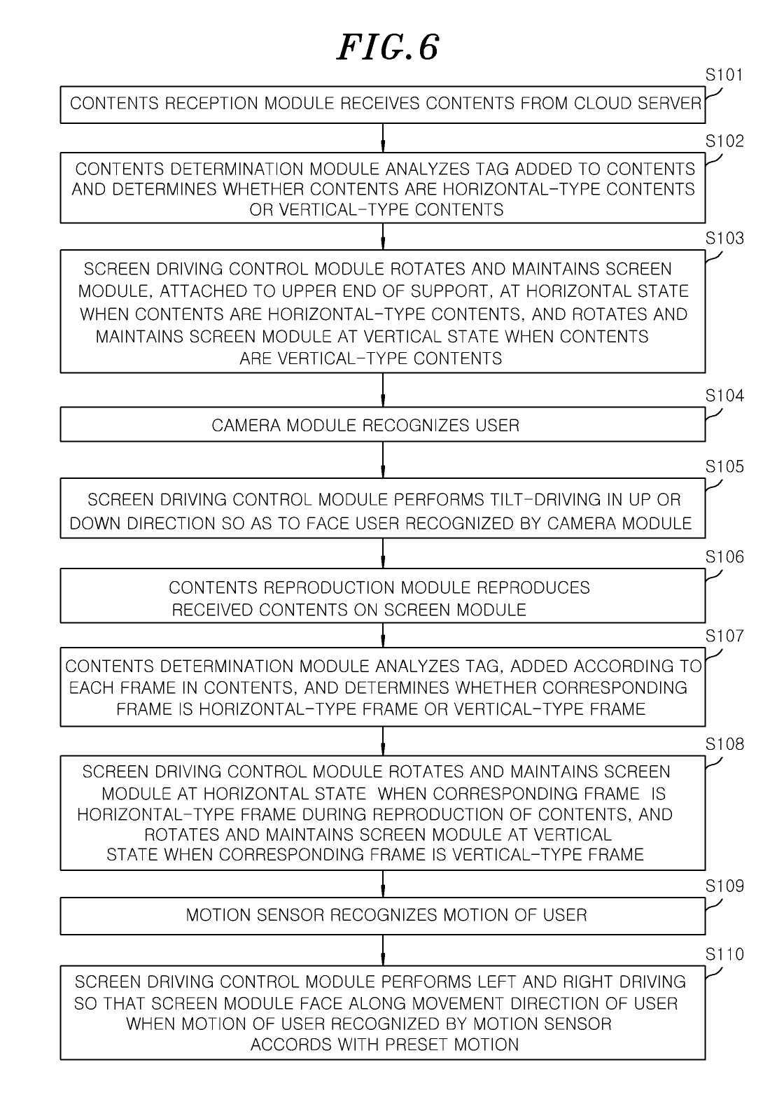

FIG. 6 is a flowchart illustrating a method for driving the contents-responsive kiosk according to an exemplary embodiment of the present invention.

Referring to FIG. 6, the contents reception module 130 receives contents from the cloud server 200 in step S101.

Next, the contents determination module 140 analyzes a tag added to the contents, which have been received by the contents reception module 130, and determines whether the contents are horizontal-type contents or vertical-type contents in step S102.

When the contents are horizontal-type contents as a result of the determination, the screen driving control module 150 rotates the screen module 120, which has been attached to the upper end of the support 110, to be at a horizontal state and then maintains the screen module 120 at the rotated state; and when the contents are vertical-type contents, the screen driving control module 150 rotates the screen module 120 to be at a vertical state and then maintains the screen module 120 at the rotated state in step S103.

Next, the camera module 170 recognizes a user in step S104.

Then, the screen driving control module 150 performs a tilt-driving in an up or down direction in step S105 so as to face the user recognized by the camera module 170.

Next, the contents reproduction module 160 reproduces the contents, which have been received by the contents reception module 130, on the screen module 120 in step S106.

Then, the contents determination module 140 analyzes a tag, which has been added according to each frame in the contents, during the reproduction of the contents and determines whether the frame is a horizontal-type frame or a vertical-type frame in step S107.

When the frame is a horizontal-type frame as a result of the determination, the screen driving control module 150 rotates the screen module 120 to be at a horizontal state and maintains the screen module 120 at the horizontal state; and when the frame is a vertical-type frame, the screen driving control module 150 rotates the screen module 120 to be at a vertical state and maintains the screen module 120 at the vertical state in step S108.

Then, the motion sensor 180 recognizes a motion of the user in step S109.

Next, when the motion of the user recognized by the motion sensor 180 accords with a preset motion, the screen driving control module 150 performs a left and right driving so that the screen module 120 can face along the movement direction of the user in step S110.

According to the contents-responsive kiosk and the method for driving the same, described above, the screen module of the kiosk rotates and maintains the screen module in a horizontal-type form, or rotates and maintains the screen module in a vertical-type form, thereby providing a screen optimized for the types of contents. The user can more conveniently appreciate contents and perform a touch task. It is possible to overcome the defect of the conventional kiosk constructed in fixed hardware, and to naturally reproduce and use contents, regardless of the types of the contents.

In addition, the contents-responsive kiosk recognizes a user using the camera module, tilt-drives the screen module in an up or down direction according to the height of the user, thereby maximizing the convenience of the user. When the user makes a specific motion, the motion sensor recognizes the specific motion, and the screen module dynamically movies in a direction to face the moving user, thereby implementing a user-centric kiosk.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. A contents-responsive kiosk comprising:
a support;
a screen module attached to an upper end of the support;
a contents reception module for receiving contents from a cloud server;
a contents determination module for analyzing a tag added to the received contents, and determining whether the contents are horizontal-type contents or vertical-type contents;
a screen driving control module for rotating and maintaining the screen module at a horizontal state when the contents are horizontal-type contents as a result of the determination, and for rotating and maintaining the screen module at a vertical state when the contents are vertical-type contents; and
a contents reproduction module for reproducing the received contents on the screen module.

2. The kiosk of claim 1, wherein the contents determination module analyzes a tag added according to each frame in the contents during the reproduction of the contents, and determines whether the corresponding frame is a horizontal-type frame or a vertical-type frame; and
the screen driving control module rotates and maintains the screen module at a horizontal state when the corresponding frame is a horizontal-type frame as a result of the determination, and rotates and maintains the screen module at a vertical state when the corresponding frame is a vertical-type frame.

3. The kiosk of claim 2, furthering comprising a camera module attached to a predetermined border of the screen module and configured to recognize a user.

4. The kiosk of claim 3, wherein the screen driving control module performs a tilt-driving in an up and down direction such that the screen module faces a user recognized by the camera module.

5. The kiosk of claim 4, further comprising a motion sensor for recognizing a motion of the user.

6. The kiosk of claim 5, wherein the screen driving control module performs a left and right driving such that the screen module faces along a movement direction of the user when a motion of the user recognized by the motion sensor accords with a preset motion.

7. A driving method of a contents-responsive kiosk comprising:
allowing a contents reception module to receive contents from a cloud server;
allowing a contents determination module to analyze a tag added to the received contents and to determine whether the contents are horizontal-type contents or vertical-type contents;
allowing a screen driving control module to rotate and maintain a screen module, which has been attached to an upper end of a support, at a horizontal state when the contents are horizontal-type contents as a result of the determination, and to rotate and maintain the screen module at a vertical state when the contents are vertical-type contents;
allowing a camera module to recognize a user;
allowing the screen driving control module to perform a tilt-driving in an up or down direction so as to face the user recognized by the camera module; and
allowing a contents reproduction module to reproduce the received contents on the screen module.

8. The method of claim 7, further comprising:
allowing the contents determination module to analyze a tag added according to each frame in the contents during the reproduction of the contents, and to determine whether the corresponding frame is a horizontal-type frame or a vertical-type frame; and
allowing the screen driving control module to rotate and maintain the screen module at a horizontal state when the corresponding frame is a horizontal-type frame as a result of the determination, and to rotate and maintain the screen module at a vertical state when the corresponding frame is a vertical-type frame.

9. The method of claim 8, further comprising: allowing a motion sensor to recognize a motion of the user.

10. The method of claim 9, further comprising: allowing the screen driving control module to perform a left and right driving such that the screen module faces along a movement direction of the user when a motion of the user recognized by the motion sensor accords with a preset motion.
